(19) United States
(12) Patent Application Publication
(10) Pub. No.: US 2026/0106383 A1
(43) Pub. Date: Apr. 16, 2026

(54) ANTENNA ARCHITECTURE FOR HIGH-GAIN AND HIGH-ORDER MIMO IN 6G FR3 DEVICES

(71) Applicant: MEDIATEK INC., Hsinchu (TW)

(72) Inventors: Sang-June Park, San Jose, CA (US); Hsin-Hung Chen, Hsinchu (TW); Hsiang-Hui Chang, Hsinchu (TW); David Ritter, San Jose, CA (US)

(21) Appl. No.: 19/343,945

(22) Filed: Sep. 29, 2025

Related U.S. Application Data
(60) Provisional application No. 63/707,273, filed on Oct. 15, 2024.

(51) Int. Cl. H01Q 25/00; H01Q 3/26; H01Q 5/28; H01Q 21/20; H04B 1/00; H04B 7/0413

(52) U.S. Cl. CPC H01Q 25/001; H01Q 3/267; H01Q 5/28; H01Q 21/205; H04B 1/0003; H04B 7/0413

(57) ABSTRACT

A UE comprises an antenna array that includes a plurality of co-located and co-directional antenna elements. The antenna elements are positioned at approximately half-wavelength spacing and are oriented to radiate in a same direction. The antenna array is a passive panel and does not have integrated active components. The UE further includes a radio frequency front-end module (RF FEM) and N radio frequency (RF) chains, with N representing an integer greater than two. Each RF chain couples a respective antenna port of the antenna array to the RF FEM. A transceiver in the UE includes N digital baseband and intermediate frequency chains. Each digital baseband and intermediate frequency chain is coupled to a respective one of the N RF chains through the RF FEM. The UE is configured to perform digital beamforming through the N digital baseband and intermediate frequency chains without any analog beamforming at the antenna array.

### CROSS-REFERENCE TO RELATED APPLICATION(S)

This application claims the benefits of U.S. Provisional Application Ser. No. 63/707,273, entitled “FR3 MIMO 4×1 Conductive Switch for 6G Handsets” and filed on Oct. 15, 2024, which is expressly incorporated by reference herein in its entirety.

### BACKGROUND

### Field

The present disclosure relates generally to wireless communications, and more particularly, to techniques of implementing high-gain and high-order multiple-input multiple-output (MIMO) antenna architectures for 6G Frequency Range 3 (FR3) devices using co-located and co-directional antenna elements.

### Background

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

Frequency Range 1 (FR1: 600 MHz-7 GHz) systems, which are utilized in various wireless communication technologies such as 4G LTE, 5G NR, Wi-Fi 6/6E, and IoT applications, employ discrete conductive switches (e.g., PIN diode switches, GaAs FETs) to selectively route signals between antennas and RF chains. In a mobile device supporting FR1, antennas are typically distributed around the device, and each antenna is associated with a dedicated conductive switch. Specifically, for FR1, each RF chain requires an individual switch with separate solder lands (e.g., 1.2-2.5 mm² per switch), which increases the layout complexity in multi-antenna configurations. Additionally, the requirement for individual conductive testing per RF chain results in extended validation time.

Frequency Range 2 (FR2: 24-44 GHz) systems, designed for millimeter-wave (mmWave) applications in 5G NR, rely on Over-the-Air (OTA) testing due to the inseparable co-integration of phased-array antennas and front-end modules (FEMs). OTA testing inherently incorporates the antenna radiation characteristics, which obscures the standalone performance metrics of the FEMs, such as power amplifier linearity and low-noise amplifier noise figure. This is because the antenna is an integral part of the OTA testing process. Consequently, OTA testing requires the use of an anechoic chamber, which is both costly and time-consuming, making it impractical for high-volume production.

The development of 6th Generation (6G) Frequency Range 3 (FR3) systems, operating within the 7 GHz to 16 GHz frequency spectrum, necessitates the creation of an optimized RF testing methodology. This methodology is essential to validate key performance metrics, such as insertion loss, linearity, and signal integrity, in a more efficient and cost-effective manner.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, an apparatus is provided. The apparatus may be a user equipment (UE) for 6G Frequency Range 3 (FR3) communication. The UE comprises an antenna array that includes a plurality of co-located and co-directional antenna elements. The antenna elements are positioned at approximately half-wavelength spacing and are oriented to radiate in a same direction. The antenna array is a passive panel and does not have integrated active components. The UE further includes a radio frequency front-end module (RF FEM) and N radio frequency (RF) chains, with N representing an integer greater than two. Each RF chain couples a respective antenna port of the antenna array to the RF FEM. A transceiver in the UE includes N digital baseband and intermediate frequency chains. Each digital baseband and intermediate frequency chain is coupled to a respective one of the N RF chains through the RF FEM. The UE is configured to perform digital beamforming through the N digital baseband and intermediate frequency chains without any analog beamforming at the antenna array.

In another aspect of the disclosure, an apparatus is provided. The apparatus may be an integrated interconnect assembly for a 6G FR3 device. The assembly comprises a single integrated structure configured to carry N parallel RF signal paths, and N is an integer greater than 2. An integrated RF connector terminates the single integrated structure. This integrated RF connector has a common housing with N RF pathways and includes mating receptacle and plug components. The single integrated structure is configured to couple an N×1 RF front-end module to an FR3 transceiver. The single integrated structure is also configured to carry only RF signals and is devoid of integrated bias lines for powering active components within an antenna module.

In yet another aspect of the disclosure, an apparatus is provided. The apparatus may be a UE for 6G FR3 communication. The UE comprises a first antenna subsystem, a second antenna subsystem, and a transceiver. The first antenna subsystem is configured for FR3 mid-band operation at approximately 7 gigahertz (GHz) and includes shared antennas configured for both Frequency Range 1 (FR1) C-band operation and the FR3 7 GHz operation. The second antenna subsystem is configured for FR3 high-band operation between 13 GHz and 16 GHz and includes at least one passive antenna panel with co-located and co-directional antenna elements. Each antenna of the first and second antenna subsystems is coupled to a separate digital chain of the transceiver to enable full digital beamforming.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric slot.

FIG. 6 is a diagram showing an example of an UL-centric slot.

FIG. 7 is a diagram illustrating an N×1 antenna system architecture for a 6G FR3 device

FIG. 8 is a diagram illustrating an integrated FPC/cable and RF connector assembly implementation.

FIG. 9 is a diagram illustrating antenna architectures for 6G Frequency Range 3 (FR3) implementations.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

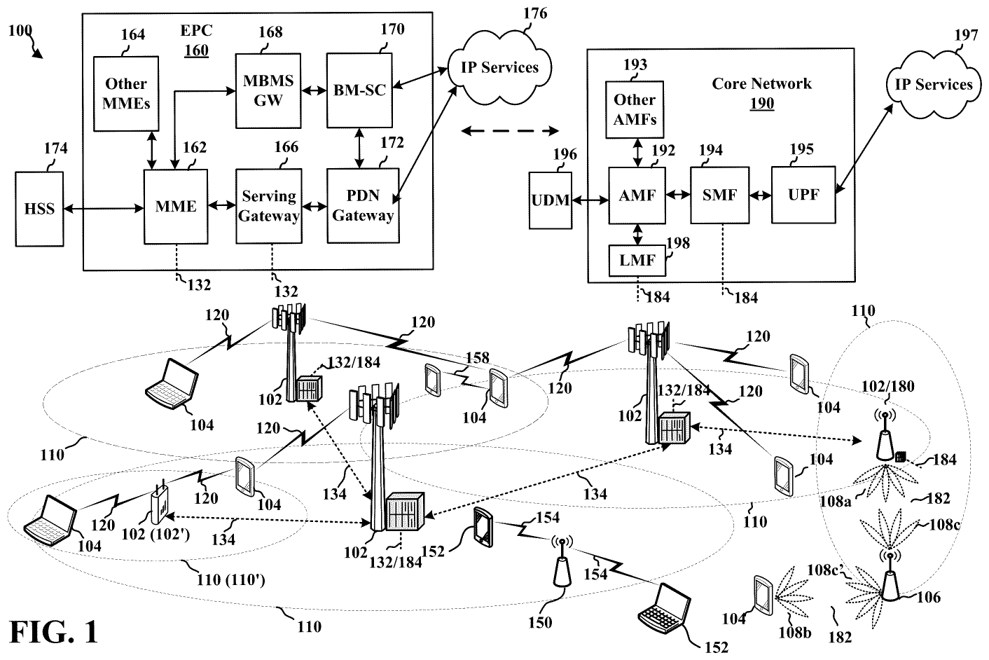

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to 7 MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

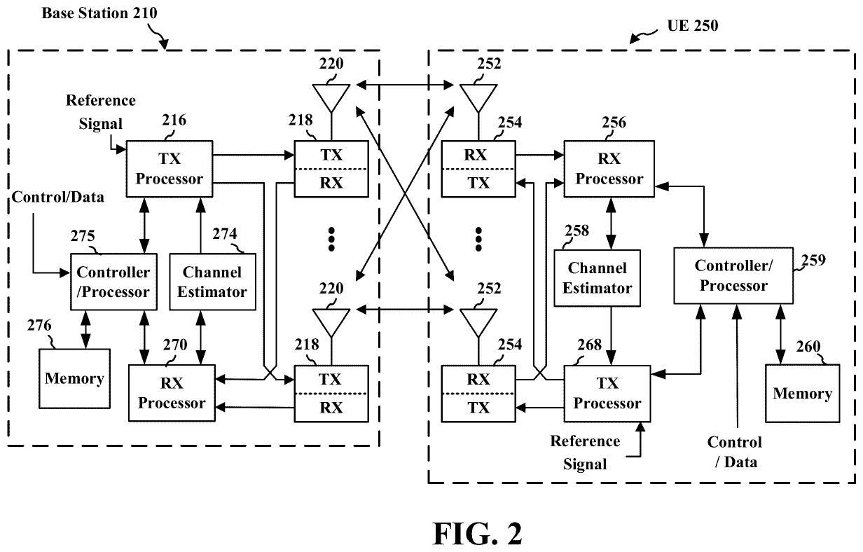

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

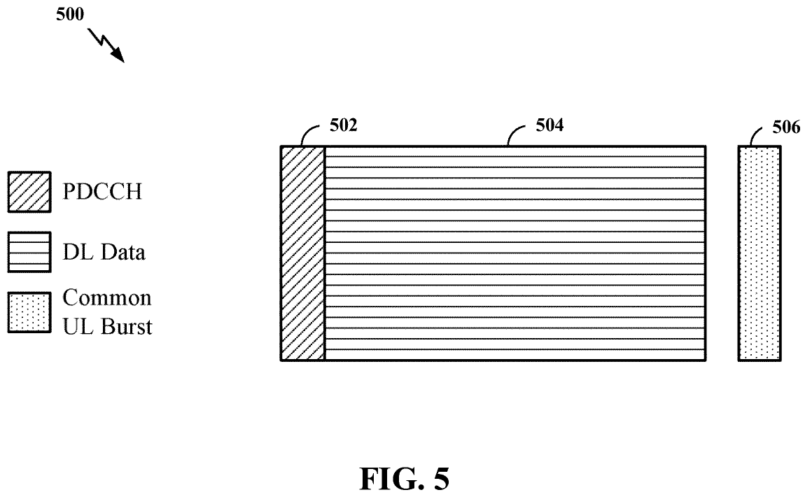

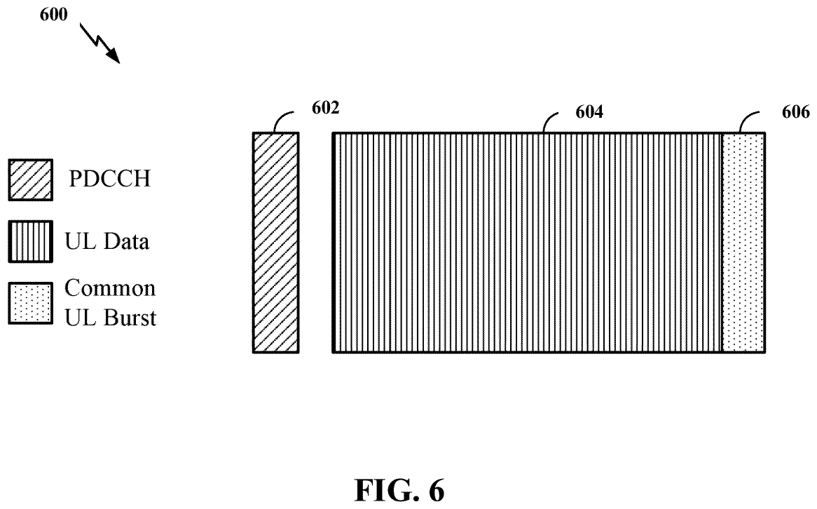

A single component carrier bandwidth of 100 MHz may be supported. In one example, NR resource blocks (RBs) may span 12 sub-carriers with a sub-carrier bandwidth of 60 kHz over a 0.25 ms duration or a bandwidth of 30 kHz over a 0.5 ms duration (similarly, 50 MHz BW for 15kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

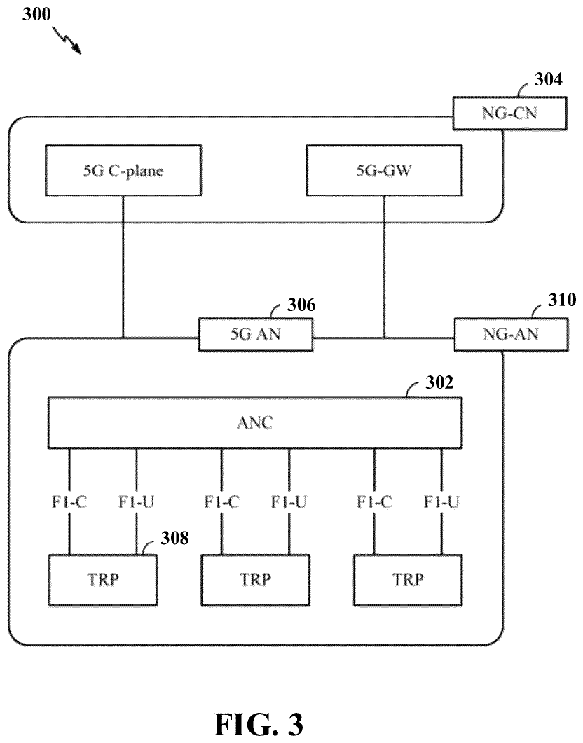

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

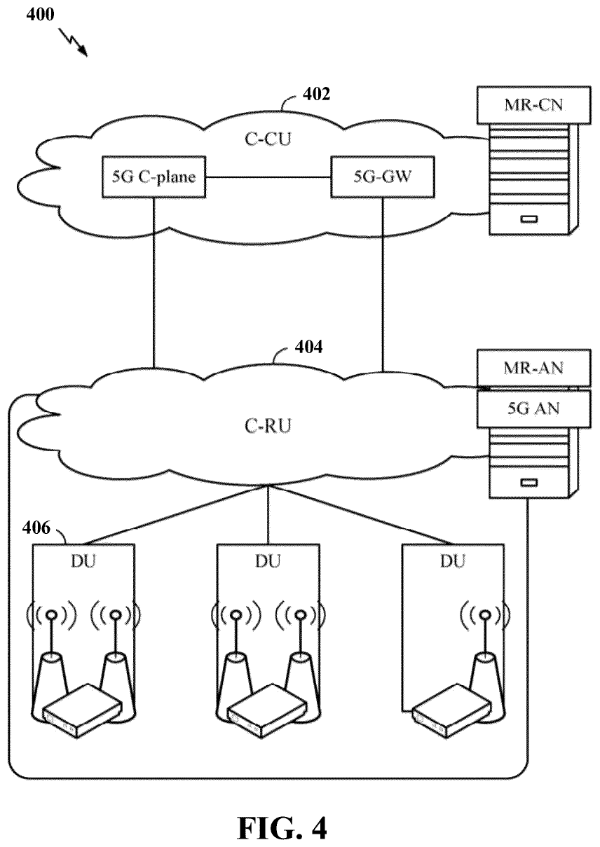

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric slot. The DL-centric slot may include a control portion 502. The control portion 502 may exist in the initial or beginning portion of the DL-centric slot. The control portion 502 may include various scheduling information and/or control information corresponding to various portions of the DL-centric slot. In some configurations, the control portion 502 may be a physical DL control channel (PDCCH), as indicated in FIG. 5. The DL-centric slot may also include a DL data portion 504. The DL data portion 504 may sometimes be referred to as the payload of the DL-centric slot. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric slot may also include a common UL portion 506. The common UL portion 506 may sometimes be referred to as an UL burst, a common UL burst, and/or various other suitable terms. The common UL portion 506 may include feedback information corresponding to various other portions of the DL-centric slot. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric slot and alternative structures having similar features may exist without necessarily deviating from the aspects described herein.

FIG. 6 is a diagram 600 showing an example of an UL-centric slot. The UL-centric slot may include a control portion 602. The control portion 602 may exist in the initial or beginning portion of the UL-centric slot. The control portion 602 in FIG. 6 may be similar to the control portion 502 described above with reference to FIG. 5. The UL-centric slot may also include an UL data portion 604. The UL data portion 604 may sometimes be referred to as the pay load of the UL-centric slot. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric slot may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric slot and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

The deployment of 6G systems in Frequency Range 3 (FR3), which includes bands around 7 GHz and 14 GHz, presents several challenges. A primary objective is to achieve network coverage comparable to existing Frequency Range 1 (FR1) systems to allow for the co-location of FR1 and FR3 base stations, thereby avoiding the high cost of deploying additional infrastructure. However, the higher frequencies of FR3 result in significantly greater signal path loss, which limits range and complicates achieving coverage parity. Furthermore, to enable a viable smartphone market for 6G FR3, the antenna system must deliver high gain without resorting to the expensive Antenna-in-Package (AiP) or Antenna-in-Module (AiM) solutions common in millimeter-wave (mmWave) systems. These AiP modules integrate antennas with active components including Radio Frequency Integrated Circuits (RFICs) and Power Management Integrated Circuits (PMICs). The integration of these active components transforms what could be a simple passive antenna panel into a complex, proprietary product that significantly increases costs and creates vendor dependencies that Original Equipment Manufacturers (OEMs) seek to avoid.

Additionally, to support the enhanced data rates expected in 6G, the antenna system must facilitate higher-order multiple-input multiple-output (MIMO) configurations, such as 4×4 or 8×8 MIMO. Current mmWave AiP architectures typically support only 2×2 MIMO due to their two-layer limitations, even when incorporating multiple antenna elements. The 6G FR3 antenna system must also support conductive testing capabilities to avoid the time-consuming and expensive over-the-air (OTA) 3GPP conformance testing required for systems with integrated analog beamforming.

To address these challenges, an N×1 antenna system architecture is proposed for 6G FR3 devices, where N is an integer of two or greater. This architecture utilizes a panel of multiple antenna elements that are co-located and co-directional. Co-located refers to positioning the antenna elements in close proximity to one another at around half-wavelength spacing, while co-directional means orienting them to radiate in the same direction. This arrangement enables coherent gain, where signals from multiple antennas combine constructively in the far field, enhancing overall signal strength and extending the communication range to mitigate the high path loss of FR3 frequencies.

The system employs fully digital beamforming, where each antenna port connects to a separate RF chain and interfaces directly with a dedicated digital port on the transceiver. This direct digital connectivity eliminates the need for analog beamforming components at the antenna panel, providing the flexibility to support higher-order MIMO operations while enabling cost-effective conductive testing. The architecture differs from conventional hybrid beamforming approaches used in mmWave systems, where analog beamformers are integrated with the antenna module to minimize path loss at extremely high frequencies.

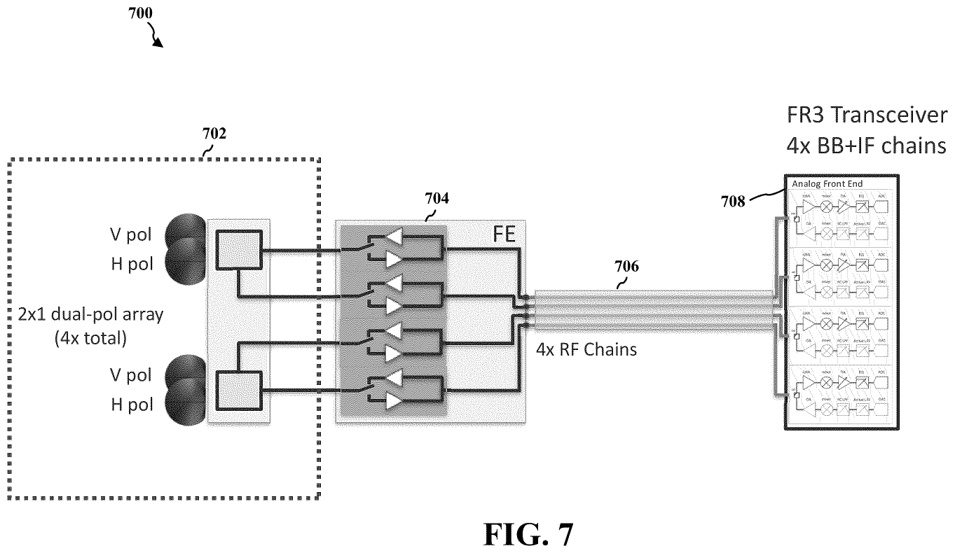

FIG. 7 is a diagram 700 illustrating an N×1 antenna system architecture for a 6G FR3 device. The system comprises an antenna array 702, a radio frequency front-end module (RF FEM) 704, RF chains 706, and an FR3 transceiver 708. In this implementation, the antenna array 702 is configured as a 2×1 dual-polarized array, including two patch antenna elements. Each antenna element supports both vertical polarization (V-pol) and horizontal polarization (H-pol), resulting in four antenna ports total. These four ports connect through the RF FEM 704 to the four RF chains 706, which interface with four digital baseband and intermediate frequency (BB+IF) chains in the FR3 transceiver 708. This configuration enables 4×4 MIMO operation through full digital beamforming.

The antenna array 702 is implemented as a passive panel containing only the antenna elements themselves, without any integrated active RFICs, PMICs, or analog beamforming circuits. This passive architecture represents a departure from conventional millimeter-wave antenna modules. The co-located placement of the antenna elements within the array 702, combined with their co-directional orientation, produces aligned radiation patterns that achieve coherent gain when transmitting, while maintaining MIMO diversity capabilities for reception.

The proposed architecture becomes technically and economically viable for FR3 frequencies due to the manageable path loss characteristics at these frequencies. Operating at frequencies up to 14 GHz, the FR3 system experiences front-end path losses typically below 2 dB, which is substantially lower than the prohibitive losses encountered in mmWave systems operating at 28 GHz or 39 GHz. This manageable loss characteristic allows the passive antenna panel to be physically separated from the RF FEM 704 and the transceiver 708, with connections maintained through RF traces or flexible printed circuits (FPCs) without significant signal degradation.

In contrast, conventional mmWave systems must integrate the RFIC directly onto the antenna panel to minimize routing distances and associated path losses. This integration requirement drives the adoption of hybrid beamforming architectures, where analog beamformers at the antenna module work in conjunction with digital beamforming at the transceiver. The resulting integrated modules become complex assemblies that include not only antennas but also analog beamformers, RFICs, and PMICs. While this integration addresses the technical challenge of high path loss, it creates expensive, proprietary products that establish vendor lock-in situations unfavorable to OEMs.

The passive panel approach of the proposed FR3 architecture offers significant cost advantages. Since the antenna panel contains only passive antenna elements, it can be manufactured by any qualified printed circuit board (PCB) vendor using standard processes. This contrasts sharply with proprietary AiP modules that require specialized manufacturing capabilities and create vendor dependencies. The elimination of active components from the antenna panel also simplifies the interconnection requirements. While FR2 AiP modules require complex FPCs carrying multiple bias lines to power active components, control signals, clock signals, and RF traces, the proposed FR3 system's interconnects primarily route RF signals, resulting in simpler and less expensive FPC designs.

The system architecture supports flexible antenna configurations to meet varying requirements. For applications requiring N total RF ports, the system can be implemented using either dual-polarized or single-polarized antenna elements. In a dual-polarized configuration, N/2 antenna elements provide N ports (with each element supporting two polarizations), while in a single-polarized configuration, N antenna elements provide N ports. For example, the 2×1 dual-polarized array shown in FIG. 7 uses two antenna elements to provide four ports, enabling 4×4 MIMO operation.

The antenna system is designed for practical integration into compact FR3 devices such as smartphones and tablets. An enabler for device integration is the use of high dielectric constant (DK) materials in the antenna panel substrate. The lower frequencies of FR3 compared to mmWave would normally require proportionally larger antennas-for instance, the wavelength at 14 GHz is approximately 10 mm, double that of 28 GHz at about 5 mm. However, advanced high-DK technology compensates for this size increase by reducing the effective wavelength within the substrate material. This allows the FR3 antenna panel to be miniaturized to dimensions comparable to FR2 panels, facilitating integration by device manufacturers without significantly impacting the device's internal layout.

Implementation flexibility extends to various integration approaches within the device. The antenna panel can be integrated directly onto the device's main PCB, embedded within the device's metal housing where many modern smartphones already incorporate antenna structures, or implemented on the display using Antenna-on-Display (AoD) technology. Each approach offers different trade-offs in terms of performance, manufacturing complexity, and space utilization.

The co-located antenna configuration of the N×1 architecture facilitates system integration and consolidation. When antenna elements are positioned in close proximity, associated front-end components can also be co-located and potentially integrated into a single package. This enables the creation of an integrated N×1 FEM that consolidates multiple amplifiers and supporting circuits. Signal routing through an FPC supporting N RF chains replaces the conventional FR1 approach of using separate discrete modules for each chain. The integration can extend to incorporating low-noise amplifiers (LNAs) and power amplifiers (PAs) along each digital signal path within the FEM 704, creating a cohesive system architecture.

The architecture exhibits modularity and scalability to address diverse deployment scenarios. Devices can incorporate multiple groups of co-located, co-directional antenna panels to improve omnidirectional coverage. For instance, a smartphone might include one panel on one side and a second panel on the opposite side, with each panel oriented in a different direction (such as 180 degrees apart). This multi-panel configuration maintains robust performance regardless of device orientation while preserving the coherent gain benefits of each individual co-located, co-directional panel.

The system scales to support various MIMO configurations based on operator and application requirements. For 8×8 MIMO operation, which network operators have expressed strong interest in for FR3 deployment, the implementation can utilize either a single 4×1 dual-polarized antenna panel providing eight total ports, or two separate 2×1 dual-polarized panels each providing four ports. This flexibility allows device manufacturers to optimize the antenna configuration based on available space and performance requirements. The support for 8×8 MIMO represents a significant advancement over the 2×2 MIMO limitations of current FR2 systems and exceeds the 4×4 MIMO capabilities typical of FR1 systems.

The proposed architecture delivers substantial benefits for 6G FR3 deployment. The combination of co-located, co-directional antenna placement with digital beamforming achieves higher effective antenna gain through coherent signal combination. This increased gain extends signal propagation distance and expands coverage area, enabling the co-location of FR1 and FR3 base stations without requiring additional infrastructure deployment. For smartphone applications, the system addresses adoption barriers by improving user equipment uplink coverage and enhancing both uplink and downlink throughput performance.

From a cost perspective, the architecture provides significant advantages over existing FR2 solutions. Current FR2 implementations incur substantial expenses from multiple sources: the proprietary AiP modules themselves carry premium pricing due to their integrated active components and specialized manufacturing requirements; the complex FPCs must accommodate numerous signal types including bias lines with low DC resistance requirements for powering PMICs and active circuits, control signals, clock distribution, and RF traces; and the specialized high-frequency connectors add further cost. The bias line requirements alone create significant challenges, as maintaining low voltage drop while powering active components requires wide metal traces that consume substantial FPC area, often necessitating expensive multi-layer FPC constructions.

The proposed FR3 solution eliminates many of these cost drivers. The passive antenna panel can be manufactured using standard PCB processes by any qualified vendor, avoiding proprietary module premiums. The simplified interconnection requirements, carrying primarily RF signals without the complex bias and control lines needed for active components, allow for smaller, simpler, and more cost-effective FPC designs. Standard RF connectors can replace specialized high-frequency variants. This comprehensive cost reduction extends beyond component savings to include reduced supply chain complexity and elimination of vendor lock-in situations.

An advantage of the proposed architecture is its enablement of conductive testing methodologies. Traditional mmWave implementations employing hybrid beamforming require extensive calibration procedures. Each analog beamforming channel must be individually calibrated, typically involving ten or more channels per module. This calibration process requires expensive anechoic chambers that must themselves undergo regular calibration, creating production bottlenecks and increasing manufacturing costs. The testing must be performed over-the-air since the analog beamforming components cannot be bypassed.

The fully digital architecture of the proposed FR3 system eliminates these testing complexities. Without analog beamforming components, there are no analog channels requiring individual calibration. The system can incorporate conductive switches that allow test equipment to connect directly to the RF signal paths, bypassing the antenna elements for testing purposes. This enables rapid conductive testing using standard RF test equipment, eliminating the need for anechoic chambers and dramatically reducing test time and cost. Device manufacturers strongly prefer conductive testing capabilities, as they significantly streamline production testing and validation procedures compared to the OTA testing mandated by current mmWave architectures.

Public regulatory filings with agencies such as the Federal Communications Commission (FCC) in the United States or the European Conference of Postal and Telecommunications Administrations (CEPT) in Europe provide additional implementation details. The development path focuses on FR3 device integration, emphasizing digital beamforming implementation, RF architecture optimization, and comprehensive test methodology development.

Another aspect of the present disclosure involves optimizing the radio frequency (RF) interconnect between a front-end module (FEM) and a transceiver in 6G Frequency Range 3 (FR3) devices. The architecture incorporates an integrated N×1 flexible printed circuit (FPC)/cable and RF connector assembly, where N is an integer greater than 2 (N>2). This integrated assembly consolidates N separate RF signal paths into a single unified structure, replacing the conventional approach of using multiple discrete coaxial cables and connectors. By integrating the N RF signal chains that run from the transceiver to the front-end module, this design reduces the implementation area on the printed circuit board (PCB), lowers manufacturing costs, and simplifies assembly complexity. The integrated interconnect architecture is specifically designed to be compatible with an N×1 integrated front-end module and complements the co-located, co-directional antenna system architecture for FR3 6G devices.

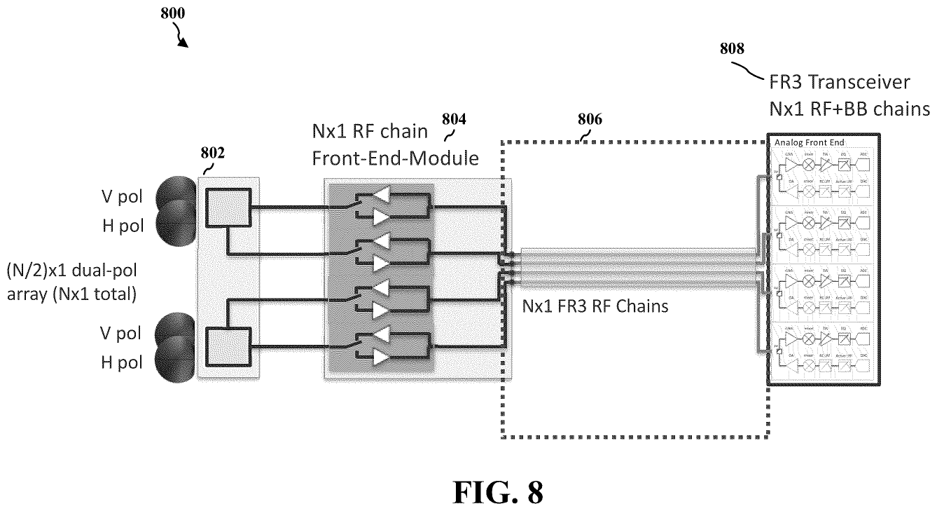

FIG. 8 is a diagram 800 illustrating an integrated FPC/cable and RF connector assembly implementation. The system comprises an antenna array 802 configured as an (N/2)×1 dual-polarized array, where each of the N/2 antenna elements supports both vertical polarization (V-pol) and horizontal polarization (H-pol), resulting in a total of N antenna ports. These N ports connect to an N×1 RF chain front-end module 804. The integrated N×1 FPC/cable and RF connector assembly 806 provides the physical and electrical connection between the RF FEM 804 and an FR3 transceiver 808, which contains N×1 RF and baseband (BB) chains for signal modulation and demodulation. The assembly 806 incorporates N parallel RF signal chains routing between these components. In the example shown in FIG. 8, the antenna array 802 includes two dual-polarized antenna elements, providing four antenna ports total, corresponding to 4×1 RF chains where N=4.

The integrated FPC/cable and RF connector assembly 806 supports multiple implementation embodiments for 6G FR3 devices. The connector implementation consists of a single integrated assembly featuring N×1 RF pathways within a common housing, complete with both receptacle and plug components that provide secure mechanical and electrical connections. The FPC implementation employs a single flexible printed circuit designed with N parallel RF routing paths or traces, eliminating the need for multiple separate FPCs. For cable-based implementations, two distinct configurations are available. The first configuration assembles N individual coaxial cables into a single integrated N×1 connector housing, where each cable maintains its individual shielding but terminates in a common connector assembly. The second configuration uses ganged cables, where N cables are physically bonded or jacketed together along their length, similar to multi-outlet power strips, providing streamlined handling and routing before terminating in the integrated N×1 connector.

The relationship between the value of N and the antenna configuration depends on the antenna polarization. For an antenna array 802 with single-polarized antenna elements, N equals the number of antenna elements, resulting in an N×1 configuration for both the connector assembly 806 and the FPC. For an antenna array 802 with dual-polarized antenna elements, N equals twice the number of antenna elements, as each element provides two ports. Specifically, when the array 802 contains N/2 dual-polarized antenna elements, the total number of antenna ports equals N, requiring an N×1 configuration for the FPC/cable and RF connector assembly 806. For example, as illustrated in FIG. 8, two dual-polarized antenna elements in the array 802 correspond to 4×1 RF chains through the assembly 806.

The proposed integrated assembly 806 offers advantages over existing FR2 implementations, which utilize complex FPC designs to route data, control signals, clock signals, and power to antenna modules. These FR2-style interconnects present multiple cost and efficiency challenges. The FR2 FPCs must accommodate numerous control, clock, and signal lines requiring extensive routing complexity. Additionally, wide bias lines are necessary to supply power to active components within Antenna-in-Module (AiM) or Antenna-in-Package (AiP) implementations, such as Power Management Integrated Circuits (PMICs) and Radio Frequency Integrated Circuits (RFICs). These bias lines must maintain extremely low DC resistance to minimize voltage drop across the FPC length. Meeting this requirement necessitates wide and thick metal traces that consume the majority of the FPC area, resulting in bulky FPC designs that often require expensive multi-layer constructions to accommodate all necessary routing.

In contrast, the proposed FR3 integrated assembly 806 primarily routes RF signals without the complex power and control requirements of FR2 systems. This simplification is possible because the associated antenna array 802 is implemented as a passive panel without integrated active components, and the RF FEM 804 can be powered locally on the PCB rather than through the interconnect. By eliminating discrete coaxial cabling and the need for high-current power delivery through the interconnect, the design reduces assembly complexity, lowers costs, and improves reliability.

The integrated design provides substantial benefits for Original Equipment Manufacturers (OEMs) implementing 6G FR3 solutions. The compact form factor of the integrated assembly 806 alleviates PCB congestion by reducing the area required for RF interconnections compared to multiple discrete coaxial cables and connectors. By consolidating N×1 RF interconnect paths into a single assembly, the solution conserves valuable device PCB area while maintaining signal integrity across all RF chains. The unified FPC and connector architecture achieves cost savings through reduced material usage and simplified manufacturing processes, as producing one integrated assembly is more economical than manufacturing and assembling N separate components. The combination of smaller area requirements, reduced component count, and lower manufacturing complexity creates a compelling value proposition for device manufacturers transitioning to 6G technologies.

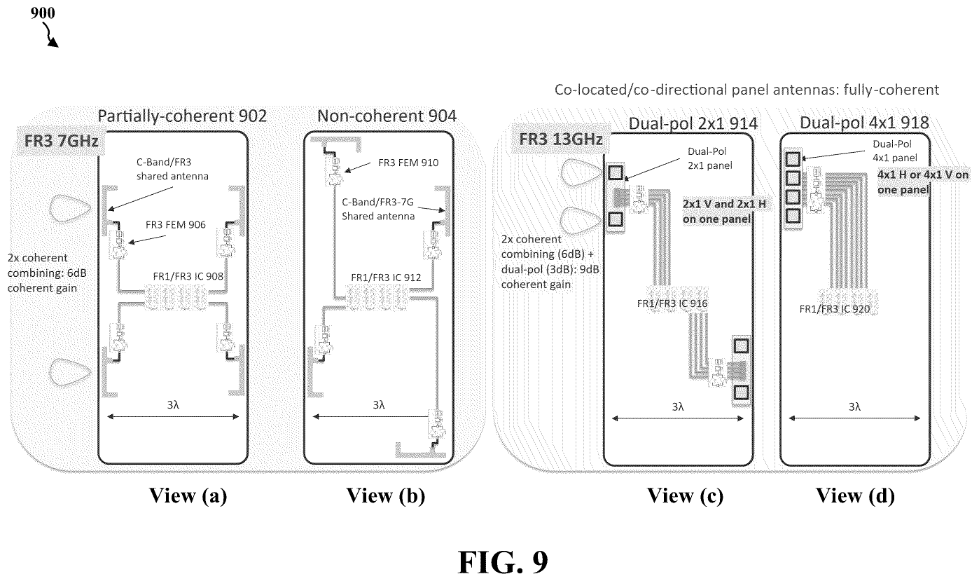

FIG. 9 is a diagram 900 illustrating antenna architectures for 6G Frequency Range 3 (FR3) implementations. The proposed architecture addresses the deployment of FR3 systems in two distinct frequency bands: a mid-band (MB) at approximately 7 GHz and a high-band (HB) at approximately 13-14 GHz. The diagram presents four different architectural approaches, shown in views (a) through (d), each optimized for specific deployment scenarios and performance requirements.

Modern smartphones incorporate extensive antenna arrays, typically containing 10 to 15 antenna elements. In one example, there are four antennas each for mid-band, high-band, and C-band operations, plus two low-band antennas, totaling 14 elements in many implementations. This antenna density creates significant spatial constraints when attempting to add FR3 capabilities to existing devices. The FR1 antennas commonly employ inverted-F antenna (IFA) designs, which appear as F-shaped radiating structures when viewed from their profile.

For FR3 mid-band operation at 7 GHz, the proposed architecture uses antenna sharing between FR3 and existing FR1 C-band implementations. Current cellular C-band specifications typically define the band as 4.4-5.0 GHz for band n79, though broader definitions extend C-band from 3 GHz to 8 GHz. This frequency proximity enables the reuse of existing C-band antenna structures by extending their frequency response to cover the FR3 7 GHz band.

View (a) of FIG. 9 illustrates a partially-coherent configuration 902 for FR3 7 GHz operation. In this architecture, C-band/FR3 shared antennas on the left side of a smartphone are positioned with co-directional alignment, enabling coherent signal combining. Each shared antenna connects to an FR3 front-end module (FEM) 906, which interfaces with an FR1/FR3 integrated circuit (IC) 908. The co-directional placement of two antennas enables 2× coherent combining, achieving a 6 dB coherent gain. The antennas maintain a separation of 3λ as indicated in the diagram. This partially-coherent approach balances antenna reuse efficiency with moderate gain enhancement.

View (b) presents a non-coherent configuration 904 where four C-band/FR3 shared antennas are oriented in different directions around the device perimeter. While this arrangement precludes coherent gain benefits, it provides improved omnidirectional coverage. Each antenna independently connects to an FR3 FEM 910 and subsequently to an FR1/FR3 IC 912. The non-coherent architecture prioritizes spherical coverage uniformity over peak gain performance, making it suitable for applications where device orientation varies frequently.

For FR3 high-band operation at 13-14 GHz, where path loss increases by approximately 6 dB compared to 7 GHz, the architecture employs dedicated co-located and co-directional panel antennas to maximize coherent gain. View (c) illustrates a dual-polarized 2×1 panel configuration 914. This panel integrates two antenna elements, each supporting both vertical polarization (V-pol) and horizontal polarization (H-pol), providing four total RF chains. The panel connects to dedicated RF chains within an FR1/FR3 IC 916. The co-located and co-directional arrangement enables both 2× coherent combining (contributing 6 dB gain) and dual-polarization diversity (contributing 3 dB gain), achieving a combined 9 dB coherent gain. The compact 2×1 panel can be replicated on opposite sides of a device to achieve 8×8 MIMO capability while maintaining 3λ spacing between elements.

View (d) depicts a dual-polarized 4×1 panel configuration 918 designed for maximum coherent gain. This architecture integrates four antenna elements in a single panel, with each element supporting dual polarization, resulting in eight RF chains total. The panel interfaces with an FR1/FR3 IC 920 that provides eight independent digital paths. The 4×1 configuration achieves 4× coherent combining, delivering 12 dB coherent gain. This single-panel solution enables 8×8 MIMO operation within a concentrated footprint, though with reduced spherical coverage compared to distributed antenna configurations.

The architectural progression from FR2 to FR3 represents a significant advancement in MIMO capabilities. While FR2 systems support only 2×2 MIMO due to hybrid beamforming limitations, and FR1 systems typically support 4×4 MIMO, the proposed FR3 architecture enables 8×8 MIMO operation. This enhancement is achieved through fully digital beamforming, where each antenna port connects to a dedicated digital chain, eliminating the analog beamforming constraints of millimeter-wave systems.

Each architecture employs specific implementation strategies to address FR3 deployment challenges. For coherent transmission, the phase-aligned transmit (TX) paths of co-located antennas combine constructively over-the-air (OTA) in the far field. This coherent combining is enabled by maintaining separate RF and digital chains for each TX path, supporting full digital beamforming. The system assumes that TX path phase delays are known through channel state information at the transmitter (CSIT), obtained via Time Domain Duplexing (TDD) system reciprocity calibration.

The co-directional alignment principle provides that all antennas within a module share identical physical orientation. For transmission, this enables coherent gain addition within the same polarization, while for reception, it maintains spatial diversity for MIMO operation. A 2×1 dual-polarized panel supports 4×4 MIMO, while a 4×1 dual-polarized panel enables 8×8 MIMO capability.

The co-located arrangement of antenna elements within compact modules simplifies RF routing requirements for smartphone integration. By positioning antenna elements at approximately λ/2 spacing within each module, the architecture preserves MIMO multiplexing gains while minimizing the spatial footprint. The use of high dielectric constant materials in the antenna substrate further enables miniaturization, allowing FR3 antenna panels to achieve dimensions comparable to existing FR2 implementations despite operating at lower frequencies.

Performance trade-offs between the single-panel and dual-panel high-band configurations reflect different optimization priorities. The 4×1 single-panel configuration in view (d) achieves superior EIRP gain, potentially reaching 15 dB through maximized coherent combining. This higher gain reduces power amplifier (PA) requirements, improving power efficiency. However, the concentration of all antennas on one side of the device results in directional coverage patterns. In contrast, the dual 2×1 panel approach shown in view (c), with panels on opposite device sides, provides more uniform spherical coverage at the expense of lower peak gain.

The proposed FR3 antenna architectures provide multiple benefits for 6G deployment. For network operators, the improved uplink coverage from coherent UE TX antennas facilitates co-location of FR1 and FR3 base stations, reducing infrastructure deployment costs. For OEMs, the passive antenna panel approach eliminates the complex and expensive Antenna-in-Package (AiP) modules required for millimeter-wave systems. The fully digital architecture also enables conductive testing capabilities, avoiding the time-consuming over-the-air calibration procedures required by hybrid beamforming systems. The implementation of higher-order MIMO configurations enhances both uplink and downlink throughput performance, while the coherent antenna arrangements optimize signal integrity and spectral efficiency for next-generation mobile communication systems.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more. ” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A user equipment (UE) for 6G Frequency Range 3 (FR3) communication, comprising:
an antenna array comprising a plurality of antenna elements that are co-located and co-directional, wherein the antenna elements are positioned at approximately half-wavelength spacing and oriented to radiate in a same direction;
a radio frequency front-end module (RF FEM);
N radio frequency (RF) chains, where N is an integer greater than 2, each RF chain coupling a respective antenna port of the antenna array to the RF FEM; and
a transceiver comprising N digital baseband and intermediate frequency chains, each digital baseband and intermediate frequency chain coupled to a respective one of the N RF chains through the RF FEM,
wherein the antenna array is a passive panel without integrated active components, and
wherein the UE is configured to perform digital beamforming through the N digital baseband and intermediate frequency chains without analog beamforming at the antenna array.

2. The UE of claim 1, wherein the antenna array comprises N/2 dual-polarized antenna elements, each dual-polarized antenna element supporting vertical polarization and horizontal polarization to provide two antenna ports, resulting in N total antenna ports.

3. The UE of claim 1, wherein the antenna array comprises N single-polarized antenna elements providing N antenna ports.

4. The UE of claim 1, wherein the antenna array is fabricated on a substrate comprising high dielectric constant material to reduce physical dimensions at FR3 operating frequencies.

5. The UE of claim 1, further comprising conductive test switches coupled to the N RF chains, the conductive test switches configured to enable conductive testing by bypassing the antenna array.

6. The UE of claim 1, wherein the antenna array is configured to operate in a FR3 high-band between 13 gigahertz (GHz) and 16 GHz.

7. The UE of claim 1, wherein the antenna array is integrated into at least one of:
a printed circuit board (PCB) of the UE;
a separate antenna panel;
a metal housing of the UE; or
a display of the UE using antenna-on-display (AoD) technology.

8. The UE of claim 1, further comprising a second antenna array, wherein the first-mentioned antenna array and the second antenna array are oriented in different directions to provide omnidirectional coverage.

9. The UE of claim 8, wherein the first-mentioned antenna array and the second antenna array are oriented 180 degrees apart on opposite sides of the UE.

10. An integrated interconnect assembly for a 6G Frequency Range 3 (FR3) device, the assembly comprising:
a single integrated structure configured to carry N parallel radio frequency (RF) signal paths, where N is an integer greater than 2; and
an integrated RF connector terminating the single integrated structure, the integrated RF connector having a common housing with N RF pathways and comprising mating receptacle and plug components,
wherein the single integrated structure is configured to couple an N×1 RF front-end module to an FR3 transceiver, and
wherein the single integrated structure is configured to carry only RF signals and is devoid of integrated bias lines for powering active components within an antenna module.

11. The integrated interconnect assembly of claim 10, wherein the single integrated structure comprises a single flexible printed circuit (FPC) with N parallel RF routing paths.

12. The integrated interconnect assembly of claim 10, wherein the single integrated structure comprises N individual coaxial cables assembled into the integrated RF connector.

13. The integrated interconnect assembly of claim 10, wherein the single integrated structure comprises ganged N cables combined along their length and terminating in the integrated RF connector.

14. The integrated interconnect assembly of claim 10, wherein N equals 4, and the assembly is configured to support 4×4 multiple-input multiple-output (MIMO) operation in an FR3 device.

15. The integrated interconnect assembly of claim 10, wherein N equals 8, and the assembly is configured to support 8×8 multiple-input multiple-output (MIMO) operation in an FR3 device.

16. The integrated interconnect assembly of claim 10, wherein the assembly is configured to reduce printed circuit board (PCB) area requirements compared to N discrete coaxial cables and connectors.

17. A user equipment (UE) for 6G Frequency Range 3 (FR3) communication, comprising:
a first antenna subsystem configured for FR3 mid-band operation at approximately 7 gigahertz (GHz), the first antenna subsystem comprising shared antennas configured for both Frequency Range 1 (FR1) C-band operation and FR3 7 GHz operation;
a second antenna subsystem configured for FR3 high-band operation between 13 GHz and 16 GHz, the second antenna subsystem comprising at least one passive antenna panel with co-located and co-directional antenna elements; and
a transceiver,
wherein each antenna of the first and second antenna subsystems is coupled to a separate digital chain of the transceiver to enable full digital beamforming.

18. The UE of claim 17, wherein the first antenna subsystem comprises at least two shared antennas positioned co-directionally to enable coherent combining with 6 decibel (dB) coherent gain.

19. The UE of claim 17, wherein the second antenna subsystem comprises a dual-polarized 2×1 panel providing four antenna ports.

20. The UE of claim 17, wherein the second antenna subsystem comprises a dual-polarized 4×1 panel providing eight antenna ports.
